(19) United States
(12) Patent Application Publication
(10) Pub. No.: US 2005/0005648 A1
(43) Pub. Date: Jan. 13, 2005

(54) Method and apparatus for fabricating an optical fiber preform in ovd

(76) Inventors: Bong-Hoon Lee, Gyeonggi-do (KR); Chan-Yong Park, Seoul (KR)

Correspondence Address: JONES DAY, 222 EAST 41ST ST, NEW YORK, NY, 10017, US

(21) Appl. No.: 10/498,628

(22) PCT Filed: Jun. 30, 2003
(86) PCT No.: PCT/KR03/02005

(30) Foreign Application Priority Data
Oct. 17, 2002 (KR) 10-2002-0063605

(51) Int. Cl. C03B 37/07

(52) U.S. Cl. 65/382; 65/414; 65/531; 65/491

(57) ABSTRACT

Disclosed are method and apparatus for fabricating an optical fiber preform in OVD (Outside Vapor Deposition) by depositing soot particles, generated by reaction of gas emitted from a burner, on a surface of a rotating mandrel. In the method and apparatus, it is controlled so that deposition concentration of the soot particles deposited on the preform is kept constant regardless of a radius of the preform or gradually increasing outward by keeping constant or gradually decreasing a trajectory velocity of a certain time on the surface of the rotating preform while depositing the soot particles.

### TECHNICAL FIELD

The present invention relates to fabrication of an optical fiber preform, and more particularly to method and apparatus for fabricating a high quality optical fiber preform by controlling the deposition process of soot particles onto the preform in the Outside Vapor Deposition (OVD).

### BACKGROUND ART

Currently, an optical fiber preform is fabricated by several methods such as MCVD (Modified Chemical Vapor Deposition), OVD (Outside Vapor Deposition), VAD (Vapor-phase Axis Deposition) and PCVD (Plasma Chemical Vapor Deposition). Among them, the OVD is broadly used since it ensures a high deposition rate and enables to fabricate a large optical fiber preform.

Referring to FIG. 1, in the OVD, a preform 4 is made by depositing soot particles 3 such as SiO₂ and GeO₂ on a mandrel 2. SiO₂, which is a soot particle used for generating the optical fiber preform, is generated to have a size of about 1 μm when a precursor chloride SiCl₄ is hydrolyzed with fuel gas such as H₂ or CH₄ and a burning product of oxygen such as H₂O, or directly oxidized with a carrier gas O₂ at or above 1100° C. according to the chemical reaction formula expressed below.

Chemical Reaction Formula 1
SiCl₄+2H₂O→SiO₂+4HCl (hydrolysis)
SiCl₄+2O₂+SiO₂+2Cl₂ (oxidization)

When deposited on the mandrel 2, GeCl₂ becomes GeO₂ through hydrolysis or oxidization reaction mentioned above. The deposition mechanism of the deposition of the soot particles such as SiO₂ and GeO₂ is thermophoresis. Thermophoresis means that, when fine particles exist in a gas having a temperature gradient, the particles move from a high temperature area to a low temperature area due to the momentum exchange between the particles and gas molecules. Thermophoresis is expressed by the following equation.

Equation 1
Vₜ=−(Kv/T)/ΔT
where Kᵥ is a thermophoresis constant, and ΔT is a temperature gradient.

According to Equation 1, it will be known that the temperature gradient significantly affects on the particle deposition. In the OVD, the soot particles such as SiO₂ and GeO₂ generated by hydrolysis or oxidization move together with high temperature gas emitted from a burner 1. The soot particles are deposited and accumulated on the mandrel 2 by the temperature gradient with passing around the mandrel 2, thereby making the preform 4.

Generally, in order to progress the above process, oxygen and hydrogen should be well supplied as combustion gas for better reaction. However, it is conventionally impossible to supply sufficient heat flow for maintaining a suitable temperature of the preform in correspondence with a surface rotating speed and a volume of the preform, which are increased as the outer diameter of the preform increases according to the deposition. In addition, the prior art cannot provide sufficient time for growth of the particles in the flame.

On the other hand, during the sintering process for sintering the preform 4 on which soot particles are deposited, volume and length of the preform are shrunk as much as 20 to 30% due to the combination of particles, and the outer diameter of the preform is also decreased as much as 10 to 30%. Thus, a separate process for removing many impurities generated in the sintering process, for example hydroxyl ions (OH⁻) or air bubbles, should be conducted.

In order to solve such problems, a method for maintaining a distance between a burner and a preform constant with moving the burner according to the progress of the process is disclosed in U.S. Pat. No. 4,731,103.

FIG. 2 is a graph showing a size of SiO₂ particle which is grown according to the time during which SiCl₄ gas output from the burner passes through the flame, the time being proportional to the distance between the burner and the preform. Referring to FIG. 2, it is understood that SiCl₄ grows into SiO₂ particle bigger and bigger with passing through the flame. To obtain a high quality optical fiber preform, it is preferred that particles having a suitable size are deposited. The method of maintaining the distance between the burner and the preform with moving the burner according to the progress of process as disclosed in the U.S. patent is suitable for controlling particles to be deposited with a constant size, but cannot solve the unbalance of soot particle deposition concentration caused by the deficiency of heat flow.

FIGS. 3a to 3d show deposition concentration and deposition particle size according to the radius change of the preform in the prior art. Referring to FIG. 3a, it will be understood that a size of the particle to be deposited on the preform gradually decreases as the radius of the preform increases in case the burner is not controlled in a vertical direction. In addition, the soot deposition concentration deposited on the preform is decreased as the radius increases, as shown in FIG. 3b. FIG. 3c shows a result of the above-mentioned U.S. patent in which the distance between the burner and the preform is kept constant. In this case, though the size of deposited particles is constant, the deposition concentration of soot is also decreased as shown in FIG. 3d since the surface moving speed of the preform becomes faster as the radius increases.

FIG. 4 shows a temperature gradient and a sintering rate distribution along a radius of the preform in the sintering process in case the deposition concentration decreases as the outer diameter increases. Since the sintering process is conducted in a separate sintering furnace, the preform is heated from its outer surface. Thus, in order to increase the temperature in the whole preform uniformly, the preform should be slowly heated from a low temperature, which results in elongation of time required for fabrication of the preform. In addition, due to the decrease of concentration from the inner circumference to the outer circumference, the sintering speed is far faster at the outer circumference of the preform as shown in FIG. 4, and this causes incomplete sintering of the preform and generation of cracks in the preform due to the shrinkage difference of the inner and outer portions of the preform.

As another example for solving this problem, a method for increasing a feed rate of combustion gas such as hydrogen and oxygen in order to supplement deficient heat flow per a unit surface area of the preform caused by the increase of diameter of the preform. However, the increase of heat flow causes the rise of the flame temperature, thereby affecting on the growth and deposition of particles. By such reasons, controlling soot particles to be deposited on the preform is still very difficult.

### DISCLOSURE OF INVENTION

The present invention is designed to solve the above problems of the prior art, and therefore an object of the invention is to provide method and apparatus for fabricating an optical fiber preform, which is capable of preventing cracks, snow balls and incomplete vitrification generated as the preform is large-sized as well as shortening the time required for sintering the preform, resultantly for fabricating the preform, by controlling deposition concentration and size of deposited particles while the soot particles such as SiO₂ are deposited on a mandrel in OVD (Outside Vapor Deposition).

In order to accomplish the above object, the present invention provides a method for fabricating an optical fiber preform in OVD (Outside Vapor Deposition) by depositing soot particles, generated by reaction of combustion gas emitted from a burner, on a surface of a rotating mandrel, wherein the method controls deposition concentration of the soot particles deposited on the preform to be kept constant regardless of a radius of the preform or gradually increased toward an outer circumference of the preform by keeping constant or gradually decreasing a trajectory velocity of one point on the surface of the preform while the soot particles are deposited.

The trajectory velocity may be kept constant or gradually decreased by either gradually decreasing an angular velocity of rotation of the preform or gradually decreasing a relative horizontal velocity between the preform and the burner while the soot particles are deposited.

Additionally, it is also possible that a feed rate of the combustion gas which is contacted with one point on the surface of the preform is gradually increased while the soot particles are deposited.

According to another aspect of the present invention, there is also provided a method for fabricating an optical fiber preform in OVD by depositing soot particles, generated by reaction of combustion gas emitted from a burner, on a surface of a rotating mandrel, the method comprising the steps of: (a) setting an initial radius of a preform, an initial angular velocity of rotation, an initial relative horizontal velocity between the preform and the burner, and an initial feed rate of combustion gas of the burner; (b) calculating an initial trajectory velocity of one point on the surface of the preform by using the initial radius, the initial angular velocity of rotation, and the initial relative horizontal velocity between the preform and the burner; (c) measuring at a time t a radius of the preform which gradually increases as the soot particles are deposited; (d) calculating a trajectory velocity of the time t at one point on the surface of the preform according to the radius of the preform at the time t; and (e) controlling the angular velocity of rotation of the preform and/or the relative horizontal velocity between the preform and the burner so that the trajectory velocity at the time t becomes identical to or smaller than the initial trajectory velocity.

In order to obtain the above object, the present invention also provides an apparatus for fabricating an optical fiber preform in OVD by depositing soot particles on a rotating mandrel, comprising: a preform rotating unit for rotating the mandrel on which a preform is formed; a burner for supplying combustion gas to generate the soot particles; a horizontal burner mover for horizontally moving the burner with respect to the preform; a flow controller connected to the burner for controlling a feed rate of the combustion gas; a radius measurer for measuring a radius of the preform which is gradually increased as the soot particles are deposited; and a process controller for controlling the preform rotating unit and/or the horizontal burner mover on the basis of the radius of the preform measured by the radius measurer.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic view showing a device for fabricating an optical fiber preform in OVD according to the prior art;

FIG. 2 is a graph showing a size of SiO₂ soot particle which is grown according to the time during which a precursor SiO₄ passes through a flame;

FIGS. 3a to 3d are graphs showing a change of deposition concentration and a change of the size of deposited particle according to the radius increase of the preform when a preform is fabricated according to the prior art;

FIG. 4 is a graph showing a temperature gradient and a sintering speed in the preform when a preform is sintered according to the prior art;

FIGS. 5a to 5c are diagrams showing a trajectory velocity at a point on the surface of the preform in the general soot particle deposition process;

FIG. 6 is a graph showing a change of a surface temperature of the preform according to the increase of heat flow of a burner;

FIG. 7 is a graph showing a change of a surface temperature of the preform according to the increase of volume of a general preform;

FIG. 8 is a schematic view showing an apparatus for fabricating an optical fiber preform according to the present invention;

FIGS. 9a and 9b are flowcharts for illustrating a method for controlling deposition particles according to the present invention;

FIGS. 10a to 10d are graphs showing a change of deposition concentration and a change of the size of deposited particle according to a radius increase of the preform when a preform is fabricated according to an embodiment of the present invention;

FIG. 11 is a graph showing a temperature gradient and a sintering speed according to the radius of the preform when a preform is sintered according to an embodiment of the present invention;

FIGS. 12a to 12d are graphs showing a change of deposition concentration and a change of the size of deposited particle according to a radius increase of the preform when a preform is fabricated according to another embodiment of the present invention;

FIG. 13 is a graph showing a temperature gradient and a sintering speed according to a radius of the preform when a preform is sintered according to another embodiment of the present invention.

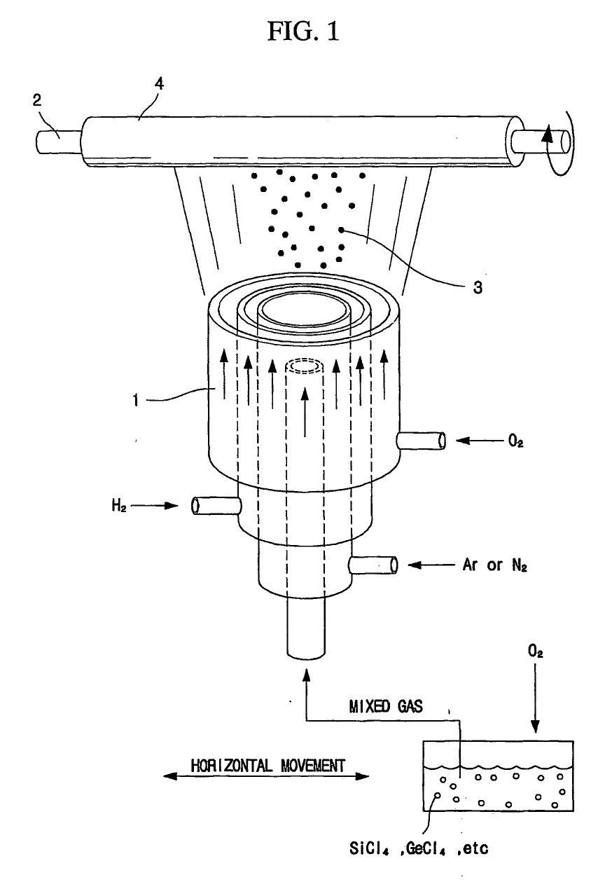

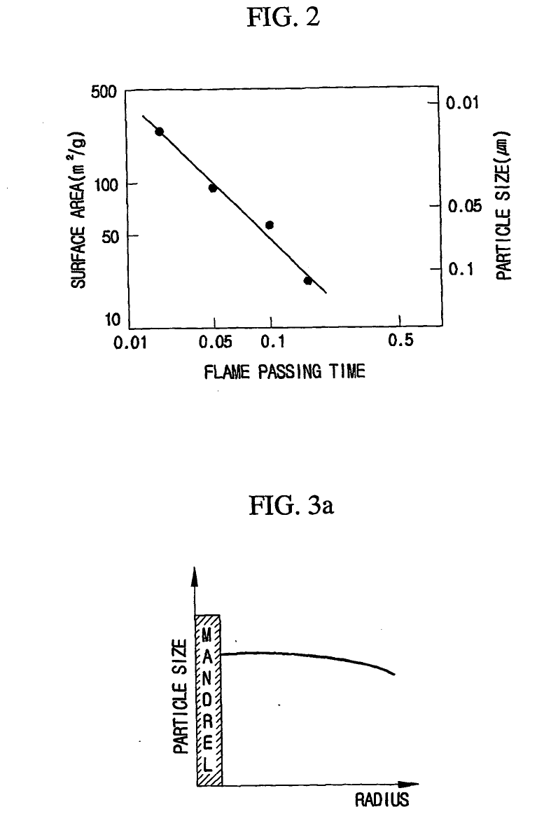

### BEST MODES FOR CARRYING OUT THE INVENTION

Hereinafter, preferred embodiments of the present invention will be described in detail with reference to the accompanying drawings. First of all, terms and words used in the specification and the claims should be interpreted not in a limited normal or dictionary meaning, but to include meanings and concepts conforming with technical aspects of the present invention, based on the face that inventors may appropriately define a concept of a term to describe his/her own invention in a best way. Therefore, the configurations described in the specification and drawn in the figures are just most preferred embodiments of the present invention, not to show all of the technical aspects of the present invention. So, it should be understood that there might be various equalities and modifications to be replaced with them.

In one embodiment of the present invention, a preform having a uniform deposition concentration regardless of the change of its radius is fabricated. In this purpose, a rotational velocity of the preform, a relative horizontal velocity between the preform and a burner, and a feed rate of combustion gas are adjusted to control the growth mechanism of soot particles. At this time, a rotational velocity of the preform, a relative horizontal velocity between the preform and a burner, and a feed rate of combustion gas applied in this embodiment are calculated as follows.

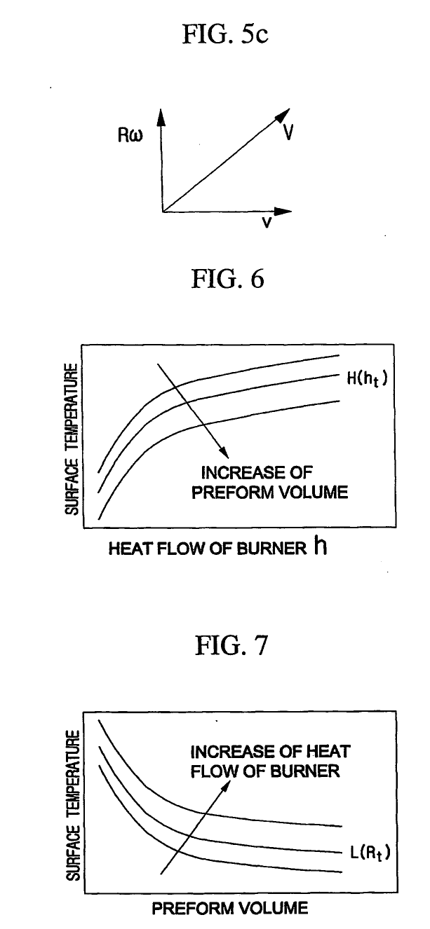

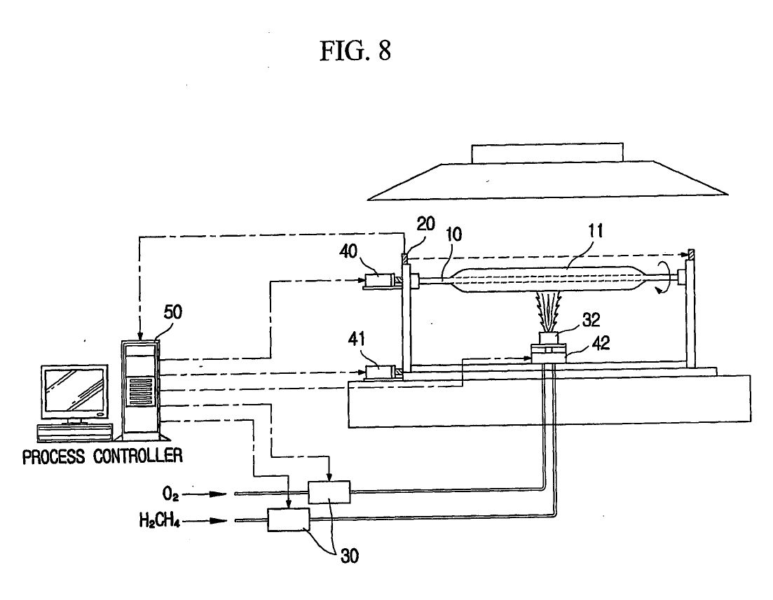

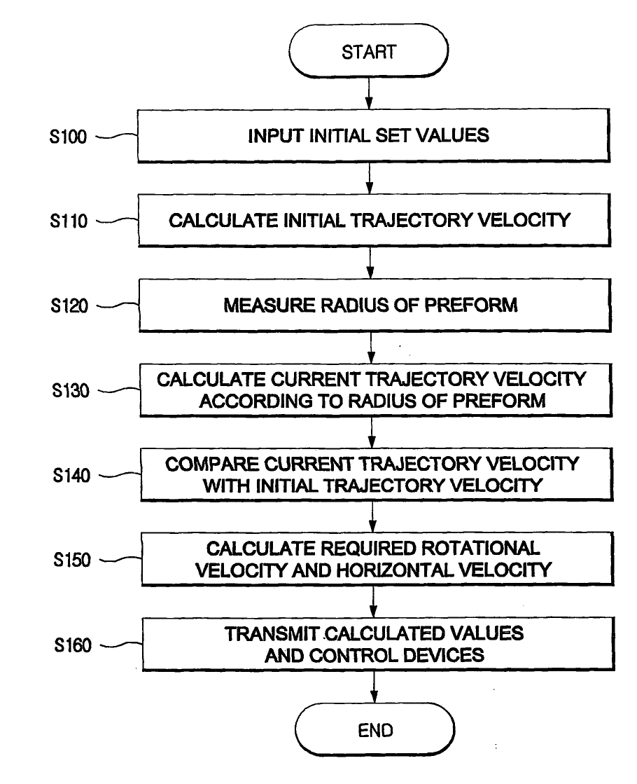

At first, the way of controlling a rotational velocity of the preform and a horizontal velocity is described. FIG. 5a shows a horizontal velocity (v) and an angular velocity of rotation (ω) of one point (A) on the surface of a preform 11 while the preform is fabricated by means of OVD (Outside Vapor Deposition), FIG. 5b shows a spiral trajectory along which the one point (A) on the surface of the preform 11 moves with circling near a burner 32 (see FIG. 8), and FIG. 5c shows a velocity vector of one point (A) on the surface of the preform 11. A trajectory velocity (V), which is a velocity of the spirally-moving point on the preform surface, is expressed by the following equation for a preform radius (R).

Equation 2
V=\sqrt{(Rω)²+v²}

In Equation 2, if the horizontal velocity (v) and the angular velocity of rotation (ω) of the preform are constant, a trajectory velocity at the point (A) on the preform 11 is gradually increased according to the increase of radius of the preform 11, and a volume of the preform is also increased in proportion to the square of radius (R). In addition, if the same heat flow is applied to the preform, the heat flow per a unit surface area is decreased rather than an initial case, so the temperature at one point (A) on the preform surface is gradually decreased along with the progress of process.

In case the heat flow per a unit time is fixed, it is assumed that, at a position where the process is initiated, a radius of the preform is R₀, a relative horizontal velocity between the preform 11 and the burner 32 is v₀, and an angular velocity of rotation of the preform is ω₀. And, if it is also assumed that a radius of the preform is Rₜ, a horizontal velocity is vₜ, and an angular velocity of rotation is ω₀ at a certain time t during the process, an initial trajectory velocity Vₒ and a trajectory velocity Vₜ during the process of a point on the preform surface which passes through the flame of the burner 32 may be expressed by the following equations.

Equation 3
Vₒ=\sqrt{vₒ²+(Rₒωₒ)²}
Equation 4
Vₜ=\sqrt{vₜ²+(Rₜωₜ)²}

If not considering the heat flow of the burner as expressed in Equations 3 and 4, it is possible to keep the temperature on the preform surface constant by controlling the angular velocity of rotation (ω) of the preform and the horizontal velocity (v) according to the change of the radius (R) during the process with the use of the trajectory velocities (V₀ and Vₜ). However, since the volume of the preform 11 increases in proportion to the square of radius according to the increase of radius (R), if there is no increase of heat flow of the burner 32, the trajectory velocity of a point on the preform surface should be gradually decreased as the process progresses in order to keep constant or gradually increase the surface temperature of the preform.

Thus, if the volume and the heat capacity are constant, the temperature at one point (A) on the preform surface is determined on the basis of a preform area which passes through a unit heat flow per a unit time. In other words, the surface temperature shows a proportional expression as shown in the following equation.

$$\begin{matrix}Temperature of \\ Preform\end{matrix} ∝ \frac{H ( {h}_{t} )}{{V}_{t}} = \frac{H ( {h}_{t} )}{\sqrt{{v}_{t}^{2} + {( {R}_{t} {ω}_{t} )}^{2}}} \qquad Equation 5$$

Here, hₜ is a burner heat flow at a certain time t, and Vₜ is a trajectory velocity of one point on the preform surface in each process, defined in Equation 4. H(hₜ) is a function of feed rate of combustion gas (hₜ) from a burner, affecting on the preform temperature, which is a monotonic increasing function satisfying the relation that H(hₜ₂)>H(hₜ₁) when hₜ₂>hₜ₁.

However, since the volume and the heat capacity of the preform increase according to the increase of radius of the preform, if the same heat flow is applied to the same size for the same time, the surface temperature becomes decreased, compared with a preform having smaller volume and heat capacity. Thus, the surface temperature of the preform has a relation as shown in the following equation for the preform area which passes through a unit heat flow per a unit time.

$$\begin{matrix}Temperature of \\ Preform\end{matrix} ∝ \frac{H ( {h}_{t} )}{{V}_{t} L ( {R}_{t} )} = \frac{H ( {h}_{t} )}{\sqrt{{v}_{t}^{2} + {( {R}_{t} {ω}_{t} )}^{2}} L ( {R}_{t} )} \qquad Equation 6$$

Here, L(Rₜ) is a function of the preform radius affecting on the preform volume, which is a monotonic increasing function satisfying the relation that L(Rₜ)>L(R₀) when Rₜ>R₀.

FIG. 6 is a graph showing the change of surface temperature of the preform according to the increase of heat flow of the burner in case the volume of the preform is constant. Lines in the graph are respectively the feed rate functions H(hₜ), showing that the surface temperature of the preform increases as the heat flow of burner increases. In addition, it would be also understood from the graph that the surface temperature decreases as the volume of preform increases.

FIG. 7 is a graph showing the change of surface temperature of the preform according to the increase of volume of the preform, in which each line is a volume function L(Rₜ). From the graph, it could be seen that, when the heat flow is constant, the surface temperature of the preform decreases as the volume of the preform increases. In addition, it would be also understood that the surface temperature increases as the heat flow increases.

In order to keep the surface temperature of the preform constant by using Equation 6 while the process progresses, a trajectory velocity (Vₜ) determined by a rotational velocity (Rωₜ) of the preform and a horizontal velocity (vₜ) at a certain time t during the process should satisfy the following equation.

$$\begin{matrix}Temperature of \\ Preform\end{matrix} ∝ \frac{H ( {h}_{t} )}{\sqrt{{v}_{t}^{2} + {( {R}_{t} {ω}_{t} )}^{2}} L ( {R}_{t} )} = \frac{H ( {h}_{o} )}{\sqrt{{v}_{o}^{2} + {( {R}_{o} {ω}_{o} )}^{2}} L ( {R}_{o} )} \qquad Equation 7$$

Thus, the trajectory velocity (Vₜ) at a certain time t resultantly satisfies the following equation.

$${V}_{t} = \sqrt{{v}_{t}^{2} + {( {R}_{t} {ω}_{t} )}^{2}} \\ = ( \frac{H ( {h}_{t} )}{H ( {h}_{o} )} ) ( \frac{L ( {R}_{o} )}{L ( {R}_{t} )} ) \sqrt{{v}_{o}^{2} + {( {R}_{o} {ω}_{o} )}^{2}} \qquad Equation 8$$

Since the compensation functions H(hₜ) and L(Rₜ) are individually obtained depending on the kind of product and process conditions, it is impossible to exhibit an exact formula, but the functions are preferably ranged as follows.

$$1 \leq H = ( \frac{H ( {h}_{t} )}{H ( {h}_{o} )} ) < 1.5 , 0.1 < L = ( \frac{L ( {R}_{o} )}{L ( {R}_{t} )} ) \leq 1 \qquad Equation 9$$

Now, an operation for controlling a rotational velocity of the preform and a horizontal velocity by using the above equations so that soot particles are deposited on the preform with a uniform deposition concentration according to an embodiment of the present invention is described.

FIG. 8 shows an apparatus for fabricating a preform according to the present invention. Referring to FIG. 8, the preform fabricating apparatus includes a high-temperature plasma burner 32 installed appropriate to a mandrel 10 made of quartz for supplying oxygen gas and combustion gas so that soot particles are deposited on the preform 11, a preform rotating unit 40 installed appropriate to the burner 32 for rotating the mandrel (or, the preform) so that soot particles are uniformly deposited on the mandrel, a horizontal mover 41 for moving the mandrel (or, the preform) or the burner 32 in a horizontal direction so that soot particles are uniformly deposited in a longitudinal direction of the mandrel 10, a vertical burner mover 42 for moving the burner 32 in a vertical direction so as to control the size of soot particles to be deposited on the preform 11, a flow controller 30 for controlling feed rates of the combustion gas and the oxygen gas supplied to the burner 32, a sensor 20 acting as a measurer for measuring a radius of the preform 11 which increases as soot particles are deposited on the mandrel, and a process controller 50 for calculating a rotational velocity of the preform, a horizontal velocity of the burner, a feed rate of the combustion gas, and a distance between the burner and the preform according to the radius measured by the sensor 20 and outputting the calculated values.

Here, when measuring the change of radius of the preform, the sensor 20 is preferably installed so that a light emitting element and a light receiving element are respectively installed at both sides of the preform to be faced with each other. In addition, the preform rotating unit 40, the horizontal burner mover 41 and the vertical burner mover 42 may adopt a step motor or a servo motor for the movement of the preform or the burner according to input signals.

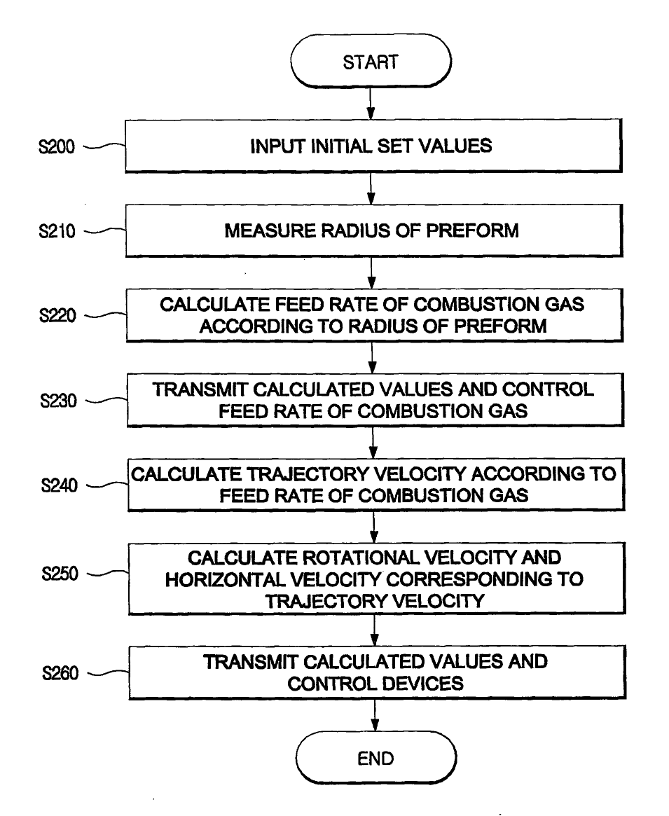

FIGS. 9a and 9b are flowcharts for illustrating a method for fabricating a preform according to the present invention. The operation of the apparatus shown in FIG. 8 is now described with reference to FIGS. 9a and 9b.

FIG. 9a shows how to control a trajectory velocity of one point on the preform surface by using the rotational velocity of the preform and the horizontal velocity of the burner in order to keep the deposition concentration of soot particles constant regardless of the change of radius of the preform, as one embodiment of the present invention. Here, the distance between the burner 32 and the preform 11 is used for controlling the size of the deposited particle, and described later.

At first, initial set values are input to the process controller 50 (step S100). The initial set values include an initial radius (R₀) of the preform, an initial angular velocity of rotation (ω₀), an initial horizontal velocity (v₀) and an initial feed rate of combustion gas (h₀).

The process controller 50 calculates and stores an initial trajectory velocity (V₀) by using the rotational velocity (Rω₀) of the preform and the horizontal velocity (v₀) according to the setting of initial values (step S110). The initial trajectory velocity (V₀) shows a movement speed of a trajectory which is drawn by one point on the preform surface. To calculate the initial trajectory velocity (V₀), the rotational velocity of the preform and the horizontal velocity are put into Equation 3.

As the process progresses, the sensor 20 senses the change of radius of the preform 11, and then transmits a current radius value to the process controller 50 (step S120).

The process controller 50 receives the radius value, which changes continuously, and calculates a current trajectory velocity (Vₜ) of the preform on the basis of the current radius value (step S130). Since the radius (R) of the preform gradually increases as the process progresses, the rotational velocity of the preform and the horizontal velocity also increase, and the trajectory velocity of the preform therefore increases during the process. The current trajectory velocity (Vₜ) of the preform, which gradually increases, may be calculated based on Equation 4, and the current trajectory velocity (Vₜ) is more preferably calculated using Equation 8 in which the compensation function values for the volume and heat capacity of the preform which change according to the increase of radius may be input.

After calculating the trajectory velocity during the process according to the change of radius, the process controller 50 compares the current trajectory velocity (Vₜ) with the initial trajectory velocity (V₀) (step S140). Since this embodiment is purposed to keep the deposition concentration of soot particles uniformly, the surface temperature of the preform should be kept constant for the uniform deposition concentration. In this reason, as a condition for keeping the surface temperature of the preform uniformly, this embodiment keeps the trajectory velocity of the preform regardless of the increase of radius of the preform.

Thus, after comparing the trajectory velocities in the step S140, the process controller 50 calculates a rotational velocity (Rωₜ) of the preform and a horizontal velocity (vₜ) required for keeping the current trajectory velocity (Vₜ) to the initial trajectory velocity (step S150). Since the trajectory velocity is a combination of the rotational velocity of the preform and the horizontal velocity as seen in Equations 3, 4 and 8, two velocities are controlled to keep the trajectory velocity constant. As a result, since the trajectory velocity of the preform tends to be gradually increased as the radius of the preform increases, the rotational velocity and the horizontal velocity of the burner are reduced correspondingly in this embodiment to keep the trajectory velocity constant.

After that, the process controller 50 transmits a control signal on the basis of the calculated values (step S160). In other words, among the calculated values, a control value for the rotational velocity of the preform is transmitted to the preform rotating unit 40, and a control value for the horizontal velocity is transmitted to the horizontal burner mover 41, respectively. The preform rotating unit 40 and the horizontal burner mover 41 then adjust rotational velocity and horizontal velocity according to the control values.

The above-mentioned procedure is continuously executed until the radius of the preform reaches a desired value.

FIG. 9b shows a modification of the above-mentioned embodiment for controlling a trajectory velocity so that the concentration of soot particles deposited on the preform may be kept constant. However, in this modification, a feed rate of combustion gas is changed, and the changed feed rate of combustion gas is reflected on the controlling of the trajectory velocity. Here, the distance between the burner and the preform is used for controlling the size of deposited particles, and described later.

In this modification, initial set values such as an initial radius (R₀) of the preform, an initial angular velocity of rotation (ω₀), an initial horizontal velocity (v₀) and an initial feed rate of combustion gas (h₀) are set and input to the process controller 50 (step S200) like the former embodiment.

As the process progresses, the sensor 20 senses the change of radius of the preform 11, and then transmits a current radius value to the process controller 50 (step S210).

The process controller 50 receives the radius value, which changes continuously, and then calculates a current feed rate of combustion gas (ht) on the basis of the current radius value (step S220). At this time, since the feed rate of combustion gas means a heat flow contacted with the surface of the preform, the current feed rate of combustion gas (hₜ) may be calculated by inputting the radius (R) of the preform, the trajectory velocities (Vₒ and Vₜ) of the preform, the change of volume of the preform (L(R)), and the initial feed rate of combustion gas into Equation 8.

If the current feed rate of combustion gas is calculated, the process controller 50 transmits a calculated value of the current feed rate of combustion gas to the flow controller 30, and the flow controller 30 then changes a feed rate of combustion gas according to the value transmitted from the process controller 50 (step S230).

Since the surface temperature of the preform changes depending on not only a feed rate of combustion gas but also a trajectory velocity of the preform, the process controller 50 calculates a currently required trajectory velocity (Vₜ) of the preform on consideration of the changed feed rate of combustion gas and the changed radius of the preform (step S240). In other words, by inputting the initial feed rate of combustion gas (hₒ) and the current feed rate of combustion gas (ht) to Equation 8, a value of the compensation function H=H(hₜ)/H(hₒ) is obtained, and a current trajectory velocity (Vₜ) is calculated.

The process controller 50 then calculates a rotational velocity of the preform and a horizontal velocity corresponding to the trajectory velocity calculated in the step S240 (step S250). Since the trajectory velocity is a combination of the rotational velocity of the preform and the horizontal velocity, the rotational velocity (Rω) and the horizontal velocity (v) are suitably calculated according to the change of radius (R) by inputting two velocities in Equations 3 or 4

The process controller 50 then transmits control signals to each device on the basis of the calculated values (step S260). In other words, among the calculated values, a control value for the rotational velocity of the preform is transmitted to the preform rotating unit 40, and a control value for the horizontal velocity is transmitted to the horizontal burner mover 41, respectively. The preform rotating unit 40 and the horizontal burner mover 41 then respectively adjust rotational velocity and horizontal velocity according to the control values.

This procedure is continued until the radius of the preform reaches a desired value.

On the other hand, together with controlling the rotational velocity (Rω) of the preform and the horizontal velocity (v) as described above, the present invention preferably controls the distance between the preform 11 and the burner 32 so that the size of soot particles to be deposited on the preform is kept constant regardless of the change of radius of the preform. In this reason, the process controller 50 controls so that the distance between the preform and the burner is kept as it initially is.

To describe this control process in more detail, an initial value for the distance between the preform and the burner is set. If the process starts, the sensor 20 measures the change of radius of the preform, and the measured value is input to the process controller 50. The process controller 50 then calculates a travel value required for maintaining the initially-set distance between the preform and the burner according to the changed radius of the preform. The calculated travel value is transmitted to the vertical burner mover 42, and the vertical burner mover 42 then moves the burner 32 vertically as much as the travel value.

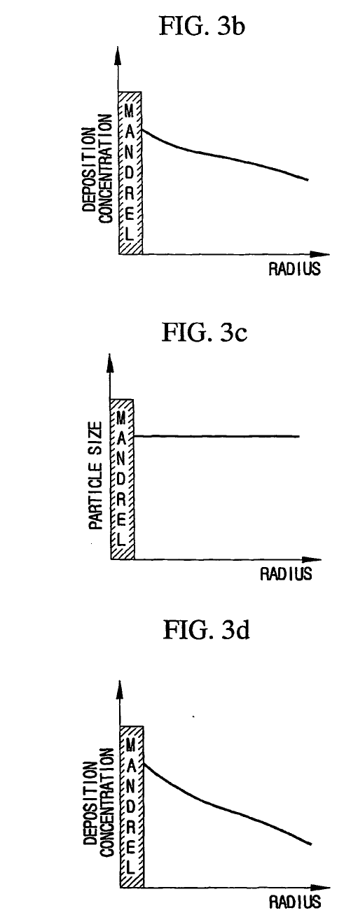

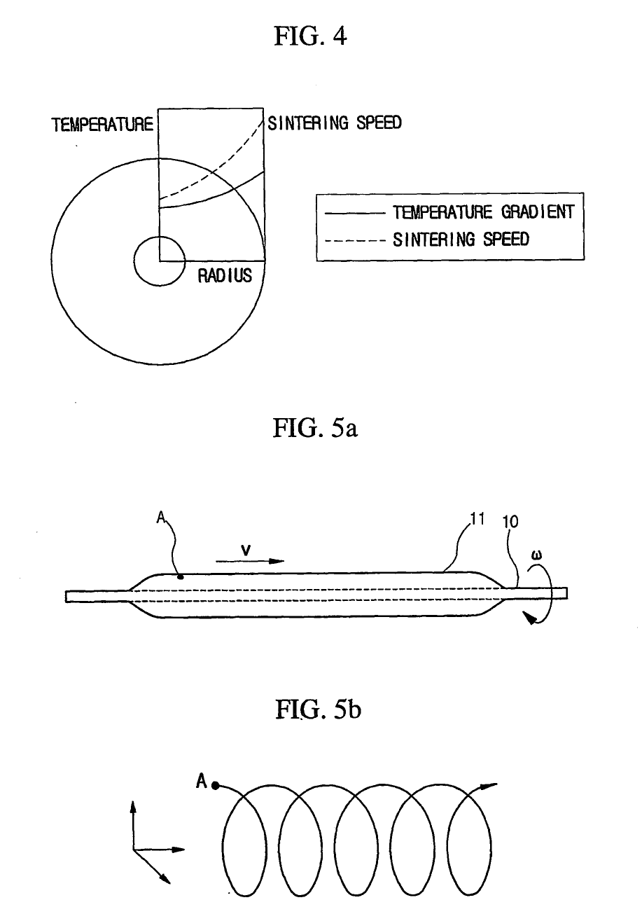

If the distance between the preform 11 and the burner 32 is not adjusted while the preform is fabricated, the soot particles such as SiO₂ to be deposited on the preform become gradually decreased. In case of being reacted appropriately with oxygen as mentioned above, the soot particles generally have size of about 0.2 to 0.25 μm. However, if the distance between the preform 11 and the burner 32 is not kept constant according to the increase of radius of the preform, the size of the soot particles deposited on the preform are decreases as the radius of the preform increases, thereby resulting in the decrease of deposition concentration. This is shown in FIGS. 3a to 3d as an example, and FIG. 4 shows an effect of the decrease of deposition concentration caused by the increase of radius of the preform on the sintering.

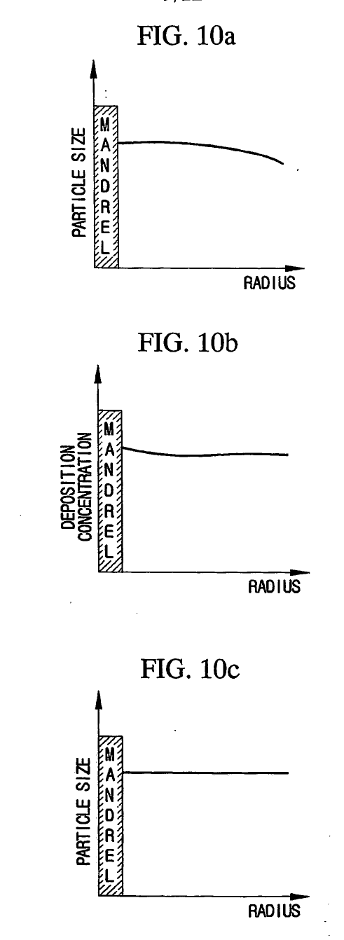

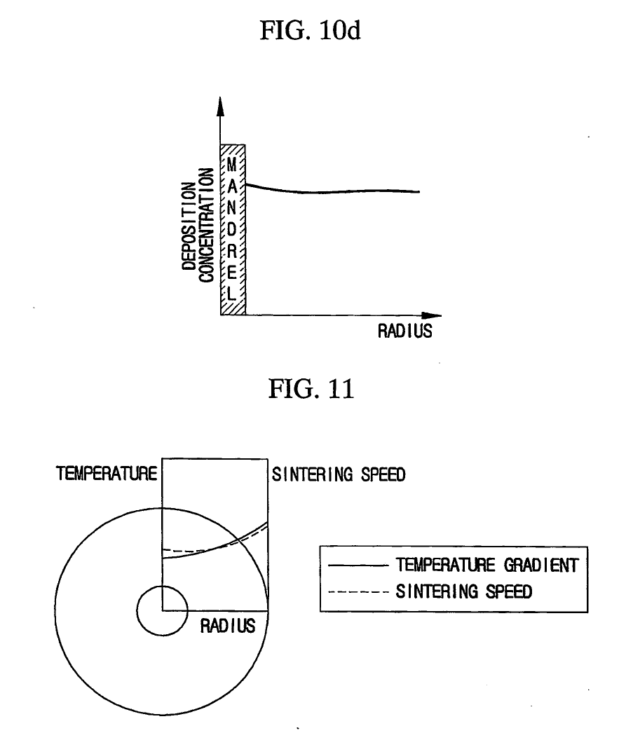

FIGS. 10a to 10d show a change of deposition concentration and a change of the size of deposited particle according to a radius increase of the preform when a preform is fabricated according to an embodiment of the present invention. In case of FIG. 10a, the trajectory velocity is kept constant according to the present invention, but the distance between the preform and the burner is not adjusted. Though the size of soot particles deposited on the preform is gradually decreases as the radius of the preform increases, the deposition concentration is not significantly decreased as shown in FIG. 10b, differently from the prior art. In case of FIG. 10c, the trajectory velocity is kept constant according to the present invention, and the distance between the preform and the burner is also adjusted constantly. In this case, the size of soot particles deposited on the preform is kept constant and the deposition concentration is also substantially kept constant though the radius of the preform increases, as shown in FIG. 10d.

Furthermore, in case the deposition concentration of soot particles is kept constant according to the increase of radius of the preform, a temperature gradient and a sintering speed are changed along with a radius of the preform as shown in FIG. 11 while a preform is sintered. For example, since the temperature gradient in the preform is seriously influenced by an external heat source and a size of the preform, the temperature gradient is not so much changed though the deposition concentration and the particle size are controlled. However, the sintering speed becomes much more uniform rather than the prior art shown in FIG. 4.

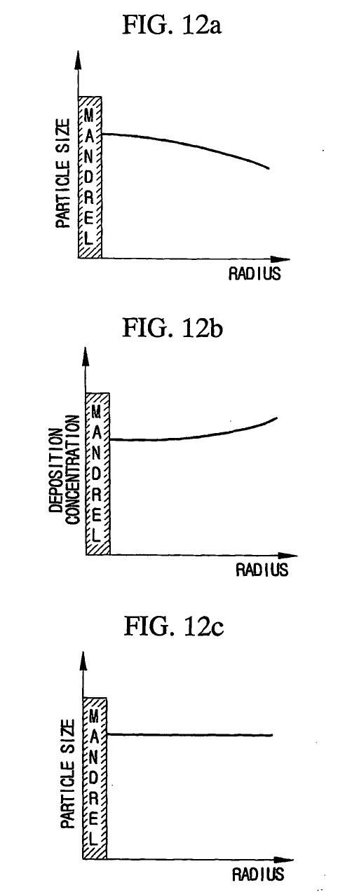

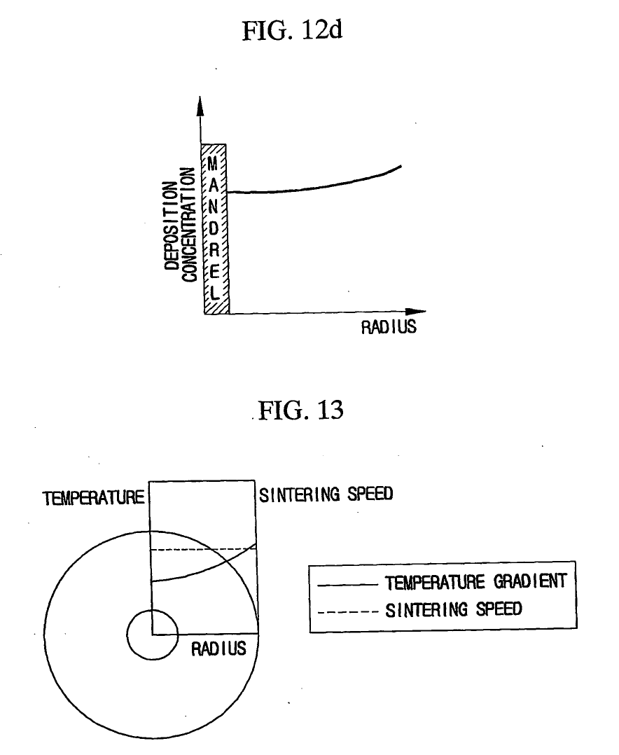

FIGS. 12a to 12d are graphs showing a change of deposition concentration and a change of the size of soot particles in case the deposition concentration is increased outwardly according to the increase of radius of the preform according to another embodiment of the present invention. In this embodiment, to increase the heat flow supplied to a unit area of the preform, a trajectory velocity (Vₜ) of one point on the preform surface according to the progress of the process is made slower than the initial trajectory velocity (Vₒ), or the feed rate of combustion gas (hₜ) is increased rather than the initial feed rate of combustion gas (hₒ).

FIG. 12a shows the case in which the trajectory velocity is kept constant, the feed rate of combustion gas is increased, but the distance between the preform and the burner is not adjusted. Though the size of soot particles is gradually decreased as the radius of the preform increases, the deposition concentration increases according to the increase of heat flow as the radius of the preform increases, as shown in FIG. 12b. In addition, FIG. 12c shows the case in which the trajectory velocity is kept constant, the heat flow is increased, and the distance between the preform and the burner is also adjusted constantly. As a result, the size of soot particles deposited on the preform is kept constant while the radius of the preform increases, and the deposition concentration is increased due to the increase of heat flow as the radius of the preform increases, as shown in FIG. 12d.

In case of sintering the preform having an increased deposition concentration of soot particles along with the increase of radius of the preform according to the embodiment of the present invention, a temperature gradient and a sintering speed are changed along with a radius of the preform as shown in FIG. 13. In other words, the temperature gradient in the preform is not changed due to the heat source generated from the inner wall of the sintering furnace, but the sintering speed becomes uniform in the preform. Thus, it is possible to sharply decrease the time required for making the temperature uniform in the whole preform, and many drawbacks such as cracks or incomplete vitrification may be solved owing to the uniform sintering speed.

Now, a method for controlling soot particles to be deposited in OVD according to the present invention is described using experimental examples.

### EXPERIMENTAL EXAMPLE 1

As an substantial application of one embodiment of the present invention, process conditions for keeping the heat flow of the burner constant in order to increase the radius of the preform as much as 30% and for maintaining the distance between the preform and the burner constantly during the process so that the size of soot particles becomes uniform may be obtained. For the supplied heat flow, a trajectory velocity (Vₜ) according to the increase of radius of the preform may be obtained, and a rotational velocity (Rₜωₜ) of the preform and a horizontal velocity (vₜ) are suitably determined according to the characteristics of the process.

TABLE 1

| Initial Process | | | Control Function Values | | Control Process | | |
|---|---|---|---|---|---|---|---|
| Variables | | | for Process Variables | | Variables | | |
| Rₒ | 10 | mm | Rₜ | 13 mm | Rₜ | 13 | mm |
| vₒ | 50 | mm/sec | L(Rₒ)/L(Rₜ) = | 0.8 | vₜ | 40 | mm/sec |
| ωₒ | 3 | rad/sec | L(10)/L(13) | | ωₜ | 1.84 | rad/sec |
| Vₒ | 58.3 | mm/sec | H(hₜ)/H(hₒ) | 1 | Vₜ | 46.64 | mm/sec |
| hₒ | 1000 | J/sec | | | | | |

| | |
|---|---|
| Position of Burner | −3 mm vertically |
| | moved |

If the radius is increased with keeping the initial process conditions as in Experimental Example 1, a preform having uniform deposition concentration may be fabricated by calculating the trajectory velocity according to the increase of radius of the preform with the use of Equation 8. Seeing Table 1, it would be understood that the heat flow supplied from the burner is constant 1,000 J/sec, but the trajectory velocity is changed from 58.6 m/sec to 46.64 m/sec. According to the present invention, the trajectory velocity should be kept constant. However, since the volume of the preform changes according to the increase of radius, the trajectory velocity is reduced rather than the initial trajectory velocity due to a compensation value of volume, 0.8.

### EXPERIMENTAL EXAMPLE 2

As an application of another embodiment of the present invention, the heat flow of combustion gas is increased as much as 20% in the state of Experimental Example 1 so that the deposition concentration of the preform increases outwardly. Process conditions of this example are shown in the following table.

TABLE 2

| Initial Process | | | Control Function Values | | Control Process | | |
|---|---|---|---|---|---|---|---|
| Variables | | | for Process Variables | | Variables | | |
| Rₒ | 10 | mm | Rₜ | 13 mm | Rₜ | 13 | mm |
| vₒ | 50 | mm/sec | L(Rₒ)/L(Rₜ) = | 0.8 | vₜ | 40 | mm/sec |
| ωₒ | 3 | rad/sec | L(10)/L(13) | | ωₜ | 1.84 | rad/sec |
| Vₒ | 58.3 | mm/sec | H(hₜ)/H(hₒ) | 1.2 | Vₜ | 46.64 | mm/sec |
| hₒ | 1000 | J/sec | | | hₜ | 1200 | J/sec |

| | |
|---|---|
| Position of Burner | −3 mm vertically |
| | moved |

In Experimental Example 2, the deposition concentration of the preform according to the increase of radius becomes higher than the case in which the deposition concentration is uniform by increasing the heat flow of the supplied combustion gas as much as 20% rather than Experimental Example 1. For example, the trajectory velocity according to the increase of radius is substantially calculated as follows: 58.3×0.8×1.2≈55.97 m/sec. However, in case of keeping the trajectory velocity constant like Experimental Example 1 and increasing the heat flow, the deposition concentration may be increased in the outer portion of the preform rather than in the inner portion, so it is possible to increase the sintering speed in the sintering process.

### INDUSTRIAL APPLICABILITY

According to the method and apparatus for fabricating an optical fiber preform in OVD, it is possible to control a sintering speed of the preform by constantly maintaining or increasing the concentration of deposition particles by control of a rotational velocity of the preform, a relative horizontal velocity between the preform and the burner and a heat flow of combustion gas, which are essential factors for determining formation of particles and concentration of deposited particles, as the preform grows. In addition, since the size of soot particles may be controlled by controlling the concentration of deposited particles and adjusting the distance between the preform and the burner, it is possible to not only increasing the sintering speed of the preform but also prevent incomplete sintering and generation of cracks, which may occur during the sintering process.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1. A method for fabricating an optical fiber preform in OVD (Outside Vapor Deposition) by depositing soot particles, generated by reaction of combustion gas emitted from a burner, on a surface of a rotating mandrel,
wherein the method controls deposition concentration of the soot particles deposited on the preform to be kept constant regardless of a radius of the preform or gradually increased toward an outer circumference of the preform by keeping constant or gradually decreasing a trajectory velocity of one point on the surface of the preform while the soot particles are deposited.

2. A method for fabricating an optical fiber preform according to claim 1,
wherein an angular velocity of rotation of the preform is gradually decreased while the soot particles are deposited so as to keep constant or gradually decrease the trajectory velocity.

3. A method for fabricating an optical fiber preform according to claim 1,
wherein a relative horizontal velocity between the preform and the burner is gradually decreased while the soot particles are deposited so as to keep constant or gradually decrease the trajectory velocity.

4. A method for fabricating an optical fiber preform according to claim 1,
wherein a feed rate of the combustion gas which is contacted with one point on the surface of the preform is gradually increased while the soot particles are deposited.

5. A method for fabricating an optical fiber preform according to claim 1,
wherein a distance between the preform and the burner is kept constant while the soot particles are deposited.

6. A method for fabricating an optical fiber preform in OVD by depositing soot particles, generated by reaction of combustion gas emitted from a burner, on a surface of a rotating mandrel, the method comprising the steps of:
(a) setting an initial radius of a preform, an initial angular velocity of rotation, an initial relative horizontal velocity between the preform and the burner, and an initial feed rate of combustion gas of the burner;
(b) calculating an initial trajectory velocity of one point on the surface of the preform by using the initial radius, the initial angular velocity of rotation, and the initial relative horizontal velocity between the preform and the burner;
(c) measuring at a time t a radius of the preform which gradually increases as the soot particles are deposited;
(d) calculating a trajectory velocity of the time t at one point on the surface of the preform according to the radius of the preform at the time t; and
(e) controlling the angular velocity of rotation of the preform and/or the relative horizontal velocity between the preform and the burner so that the trajectory velocity at the time t becomes identical to or smaller than the initial trajectory velocity.

7. A method for fabricating an optical fiber preform according to claim 6,
wherein the distance between the preform and the burner is kept constant while the preform is fabricated.

8. A method for fabricating an optical fiber preform according to claim 6,
wherein, in the step (e), the angular velocity of rotation of the preform and/or the relative horizontal velocity between the preform and the burner is controlled so that the trajectory velocity at the time t satisfies the following equation:
0.1Vₒ<Vₜ≦Vₒ
where Vₜ is the trajectory velocity at the time t, and Vₒ is an initial trajectory velocity.

9. A method for fabricating an optical fiber preform according to claim 6, further comprising the step of controlling a feed rate of combustion gas at the time t to be identical to or more than the initial feed rate of combustion gas.

10. A method for fabricating an optical fiber preform according to claim 9,
wherein, in the step (e), the angular velocity of rotation of the preform and/or the relative horizontal velocity between the preform and the burner is controlled so that the trajectory velocity at the time t satisfies the following equation:
Vₜ=HLVₒ
where Vₜ is the trajectory velocity at the time t, Vₒ is an initial trajectory velocity, H is a compensation function of the feed rate of combustion gas at the time t (1≦H<1.5), and L is a compensation function of the trajectory velocity at the time t (0.1<L≦1).

11. An apparatus for fabricating an optical fiber preform in OVD by depositing soot particles on a rotating mandrel, comprising:
a preform rotating unit for rotating the mandrel on which a preform is formed;
a burner for supplying combustion gas to generate the soot particles;
a horizontal burner mover for horizontally moving the burner with respect to the preform;
a flow controller connected to the burner for controlling a feed rate of the combustion gas;
a radius measurer for measuring a radius of the preform which is gradually increased as the soot particles are deposited; and
a process controller for controlling the preform rotating unit and/or the horizontal burner mover on the basis of the radius of the preform measured by the radius measurer.

12. An apparatus for fabricating an optical fiber preform according to claim 11, wherein the process controller controls an angular velocity of rotation of the preform rotating unit and/or a horizontal velocity of the horizontal burner mover so that a trajectory velocity of one point on a surface of the preform is constant kept or gradually decreased as the radius of the preform measured by the radius measurer is increased.

13. An apparatus for fabricating an optical fiber preform according to claim 12,
wherein the process controller controls the angular velocity of rotation of the preform rotating unit and/or the horizontal velocity of the horizontal burner mover so that the trajectory velocity at a time t satisfies the following equation:
0.1Vₒ<Vₜ≦Vₒ
where Vₜ is a trajectory velocity at the time t, and Vₒ is an initial trajectory velocity.

14. An apparatus for fabricating an optical fiber preform according to claim 11, wherein the process controller controls the flow controller so that a feed rate of the combustion gas is increased as the radius of the preform measured by the radius measurer increases.

15. An apparatus for fabricating an optical fiber preform according to claim 14,
wherein process controller controls the angular velocity of rotation of the preform rotating unit and/or the horizontal velocity of the horizontal burner mover so that the trajectory velocity at a time t satisfies the following equation:
Vₜ=HLVₒ
where Vₜ is a trajectory velocity at the time t, Vₒ is an initial trajectory velocity, H is a compensation function of the feed rate of combustion gas at the time t (1≦H<1.5), and L is a compensation function of the trajectory velocity at the time t (0.1<L≦1).
